(19) United States
(12) Patent Application Publication
(10) Pub. No.: US 2005/0097268 A1
(43) Pub. Date: May 5, 2005

(54) System for transferring data from one storage device to another

(76) Inventor: Hans Vollmer, Villingen (DE)

Correspondence Address: BRINKS HOFER GILSON & LIONE, P.O. BOX 10395, CHICAGO, IL, 60610, US

(21) Appl. No.: 10/944,130

(22) Filed: Sep. 17, 2004

(30) Foreign Application Priority Data
Sep. 19, 2003 (EP) 03021326.8

(51) Int. Cl. G06F 12/00

(52) U.S. Cl. 711/113; 711/168

(57) ABSTRACT

The application presents a data transfer interface that accelerates a data transfer between two data storage drives by performing read and write operations in concurrently. Data read from a data storage drive is buffered into a cache provided within the first data storage drive (source drive) while data previously read are transferred and written to the second data storage drive (target drive).

### PRIORITY CLAIM

This application claims the benefit of European Patent Application 03021326.8 filed in the EPO on Sep. 19, 2003, which is incorporated herein by reference.

### BACKGROUND OF THE INVENTION

1. Technical Field

This application relates to a data interface system including a method for connecting a data interface between multiple data storage drives and a control device or host. In particular, the application relates to an efficient data transfer between multiple data storage drives.

2. Related Art

Data transfer interfaces may be found in systems that transfer digital data between communication devices, such as computers, printers, and video screens. For instance, a data transfer interface permits a computer to send to and receive information from peripheral devices, including data storage drives, such as hard disk drives and optical storage media. The peripheral devices may connect to a control device or host via an AT-Attachment (ATA) bus with the IBM/AT PC format. The peripheral devices also may connect via the extended ATA bus standard, AT Attachment Packet Interface (ATAPI), known as ATA/ATAPI, and similar types of buses.

The host may execute a data transfer step where data is transferred between a peripheral device to a computer and then from the computer to another peripheral device. In this operation, only a single peripheral device at a time may be selected to perform either the read operation or the write operation, making the transfer of data time-consuming. Further delay is encountered when one data storage device has a relatively long access time or a large amount of data is to be transferred. Thus, a need exists to provide a data transfer interface that is capable of transferring the data between peripheral devices including data storage drives in a more efficient manner.

### SUMMARY

This application provides a data transfer interface system that efficiently and repetitively transfers data between two or more data storage drives. The data transfer interface system includes a control unit or host that may control the transfer of data between data storage drives that may be located on peripheral devices or on a main computer in a computer system. The system may further include a plurality of data storage drives where at least a first data storage drive (source drive) transfers data to a second data storage drive (target drive). One of the data storage drives may include a memory or cache for storing blocks of data read from one of the data storage drives.

Using the data transfer interface, data may be read from the first data storage drive to the cache where the data will be buffered and then forwarded to the host. The data that is read from the first data storage drive may be sized into appropriate blocks of data that can be stored and manipulated by the host conveniently. A block of data may be transferred to a second data storage drive from the host. While the block of data is written to the second data storage drive, a subsequent block of data may be read concurrently from the first data storage drive and then transferred to the host. The host may be adapted to control the data transfer process so that reading and storing of a block of data from the first data storage drive and transferring and writing a previously read block of data to the second data storage drive may be performed concurrently. Consequently, data may be written to the second data storage drive while data is concurrently being read from the first data storage drive. This transfer may proceed in a continuous and repetitive manner and a time savings may be achieved.

The data blocks transferred during the read and write operations may represent video, audio, navigation, and other data which may require large storage capacity. The application allows the use of such data, its efficient distribution on storage media, and provides a data copying process for easily integrating the data on a first data storage medium into a data processing system. This system may be applied in any type of computer system including a vehicle computer system, such as a vehicle navigation system or a vehicle information system.

Other systems, methods, features and advantages of the invention will be, or will become, apparent to one with skill in the art upon examination of the following figures and detailed description. It is intended that all such additional systems, methods, features and advantages be included within this description, be within the scope of the invention, and be protected by the following claims.

### BRIEF DESCRIPTION OF THE DRAWINGS

The application can be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 is an example of a connection of two data storage drives to a host.

FIG. 2 is another connection of two data storage drives to a host configured to allow concurrent communication of both data storage drives with the host.

FIG. 3 is an example of a data copying timing diagram.

FIG. 4 is an example of a data copying flow chart for two data storage drives.

FIG. 5 is an example of a data copying flow chart for “n” blocks of data.

### DETAILED DESCRIPTION OF THE PREFERRED EMBODIMENTS

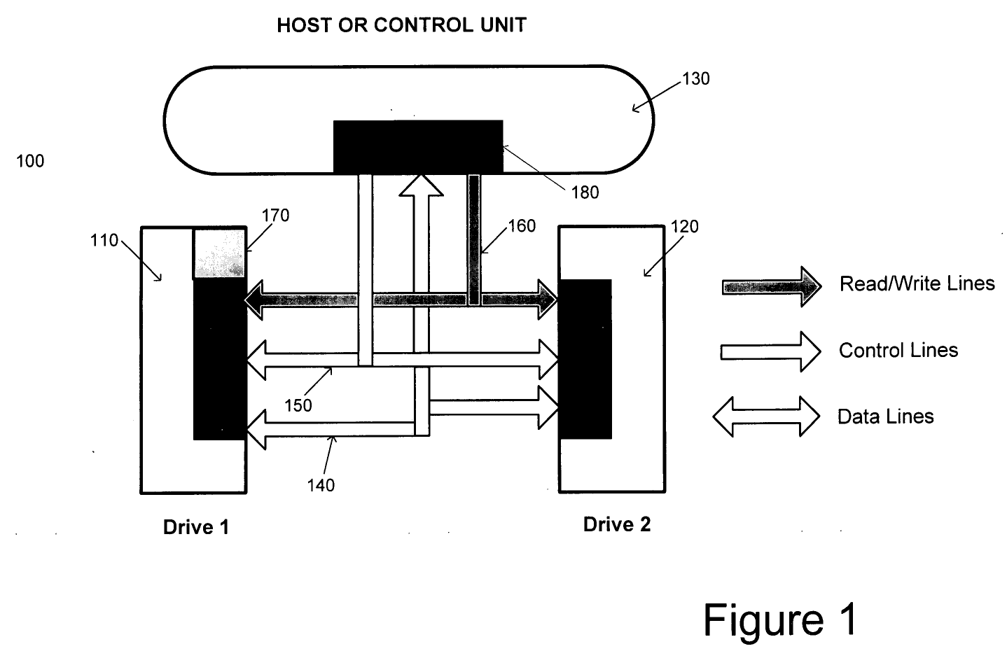

FIG. 1 shows a data transfer interface system 100 configured to transfer data from one digital storage drive 110 to another digital storage drive 120, such as during a communication session with a peripheral device using the ATA/ATAPI bus. Two data storage drives 110 and 120 are connected through a single data transfer interface 100. Examples of data storage media or drives include optical disk drives, magneto-optical drives, hard disk drives, removable media drives like floppy disk, Zip, Syquest, Bernoulli, or Jazz drives, flash memories, silicon drives, holographic storage drives, and the like. The types of data storage drives and the peripheral devices connected to the data transfer interface that include data storage drives are not limited to the explicitly mentioned data storage media. The host 130 may be a controller, a processor, or a computer system that is configured to interface with data storage drives 110 and 120. The data storage drives 110 and 120 may be remotely located or may be an integral part of a peripheral device. Both data storage drives 110 and 120 share a connector 180 provided at the host 130. A plurality of data lines 140, a plurality of control lines 150, and a plurality of read/write lines 160 jointly connect the two data storage drives 110 and 120 to the host 130. The data storage drives may also provide a register to hold values of internal operations, such as the address of the instruction being executed and the location or source of the data being processed. The register may be organized as identifier bits that are toggled by the host to indicate the operation to be executed. The host may select one of the storage drives 110 or 120 for carrying out a read or write operation by selecting a particular identifier bit in the drive register.

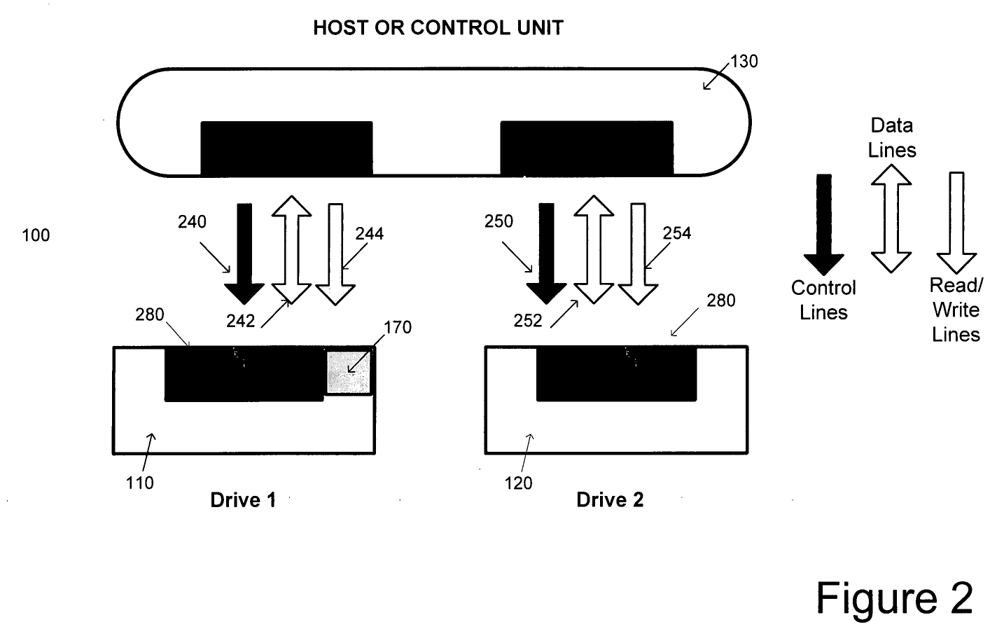

FIG. 2 shows the data transfer interface system 100 configured to allow concurrent communication of both data storage drives 110 and 120 with the host 130. A host 130 may be connected to a first data storage drive (source drive) 110, with a data line 240, a control line 242, and a read/write command line 244. While two data storage drives 110 and 120 are shown in FIG. 2, subsequent data storage drives similarly may be connected to the host 130. The read/write command line 244 may connect to a connector 280 on the first data storage drive 110. Similarly, the read/write command line 254 may connect to a connector 280 on second storage drive 120. The host or control device 130 also may connect to the two data storage drives 110 and 120 to each other. The data storage drives 110 and 120 may connect to the host 130 by individual data lines 240 and 250, individual data control lines 242 and 252, and individual read/write command lines 244 and 254, respectively. The first data storage drive (source drive) 110 may be an optical disk drive and the second data storage drive (target drive) 120 may be a hard disk drive, or vice versa. Such a disk drive combination may enable an efficient transfer of data from a medium with relatively long data access time to a rewritable storage medium with relatively short data access times.

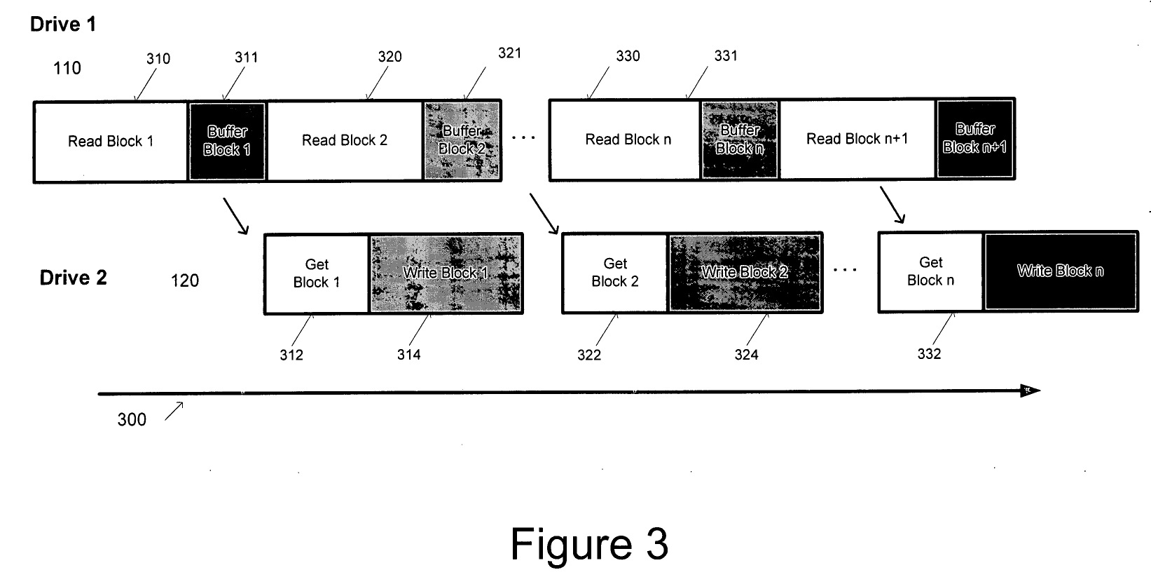

FIG. 3 illustrates a timing diagram showing a process for transferring data from the first data storage drive 110 to a second data storage drive 120 using concurrent communication between the data storage drives and the host. During the data transfer process, the read and write operations may be performed in parallel. The processing blocks of FIG. 3 are arranged with respect to a time axis 300 to show the sequential and parallel relationships of the read and write process for the subsequent data blocks. At 310, the first block of data has been obtained, for example, from the first data storage drive 110. The first block is then buffered in a cache or temporary storage location 170 as shown in step 311. The host 130 may then transfer the first block at step 312 to the second data storage drive 120 where it may be written 314 in the second data storage drive 120.

When the reading step 310 and that buffering step 311 of the first block of data have been completed, the process continues reading the second block of data, step 320. As the second block of data is read, it is buffered 321 once again in the cache 170 in FIG. 2. The timing for the read procedure for a block of data from the first data storage drive and the write procedure for a block of data to the second data storage drive may be offset such that a block is written to the second data storage drive after the data read procedure for that block has been completed. Writing a block of data to a data storage drive such as a hard disk drive may take less time than reading the bock of data from a data storage drive such as an optical data storage drive as an optical data storage drive such as a CD or a DVD has slower disk RPM compared to a conventional hard disk drive and longer wait time for disk vibration settling.

The cache 170 may be located in the first data storage drive 110 as shown in FIG. 2 or in any other data storage drive in the system. Although data transmission between the host 130 and the data storage drives 110 and 120 may be active for one data storage drive at a time, using the cache 170 on the data storage device 110, the read and write processes may be carried out concurrently, while the cache 170 in the first data storage drive 110 is continuously filled with blocks of data read from the first data storage drive. After the first block of data is processed, during step 311 in FIG. 3, the read data are buffered within the first data storage drive 110 to the cache 170, while the host 130 transfers the data from the cache 170 to the second data storage drive 120 during step 312. The second data storage drive 120 may be instructed to write received data on its storage medium in step 314 while the next block of data is being obtained from the first data storage drive 110. Efficient transfer of data may occur as reading the blocks of data from the first data storage drive 110 may proceed using the buffer 170 without waiting for the second data storage drive to complete writing previous bocks of data. This accelerated copy procedure allows the use of optical storage media for providing large amounts of data, such as update information, that may be transferred to a hard disk drive for easy access by a data processing system.

By providing a cache 170 within the first data storage drive 110, the drive 110 may continuously read data and store data in the cache 170. This continuous process may be achieved by employing a “look ahead” subroutine. The “look ahead” subroutine may be a software-implemented algorithm in the data storage drive 110. The “look ahead” algorithm analyzes the data accessed from the data storage drive 110 and makes a prediction of where the next data block will be read in the data storage drive 110. The “look ahead” algorithm fills the cache 170 with the predicted blocks of data to minimize the data transfer time when data is requested from the cache 170 by the host 130. Some commercially available disk drives may allow adjustment of the “look ahead” parameters to further optimize the data transfer speed from the cache 170 depending on the type of data read from the data storage drive 110. The cache 170 and the “look-ahead” subroutine may be implemented by any of a plurality of commercially available disk drives providing the required memory and functionality. Optimization of data exchange may be achieved when a data storage drive 110 or 120 with a slow data access time is used as a first data storage drive. For example, a DVD drive, because of the slower disk rotational RPM and wait time for disk vibration settling, has relatively long access time compared to, for example, a target hard disk drive with a short access time used as the second data storage drive. The time needed to write a block of data to the hard disk drive is considerably shorter than the time needed to read the block of data in the DVD drive. The DVD drive may continually read the blocks of data to the cache, allowing the host to continually instruct the transfer of the data to the targeted drive. Since the data flow may be continuous, the access time for the first or slower data storage drive 110 may be the limiting factor for the data transfer. By providing concurrent read and write operations, the data transfer method provided in the application minimizes the effect of the slower access time for the first data storage drive.

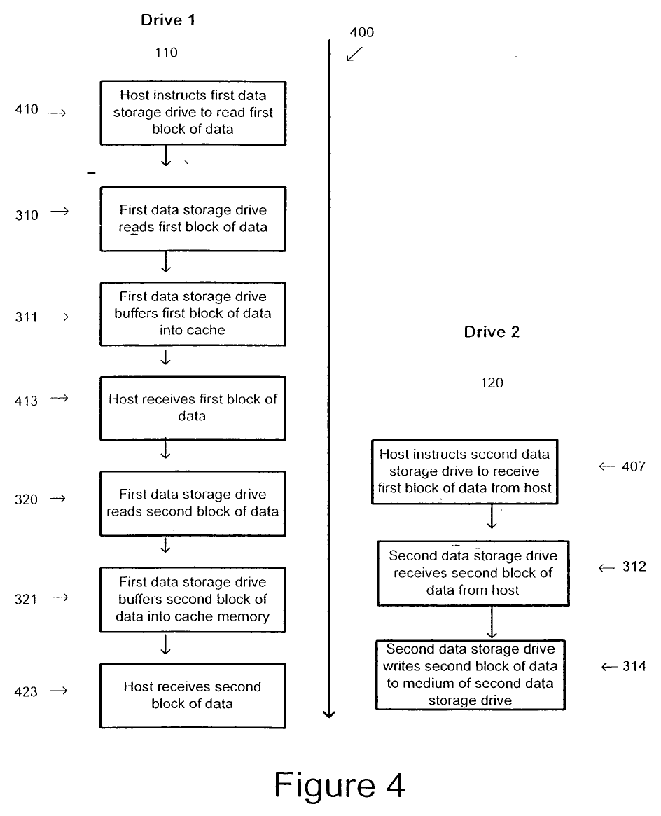

The process for transferring two blocks of data from the first data storage drive to the second data storage drive is shown in a flow diagram in FIG. 4. The flow diagrams for each column are arranged with respect to a time axis 400 to reflect the sequential and parallel relationships of the process for the blocks of data. In the first step, the host 130 instructs the first data storage drive 110 to read a first block of data 410. The first data storage drive 110 reads the first block of data at 310. The first data storage drive 110 stores the first block of data in the cache 170 at 311. The first data storage drive 110 then transfers the first block of data to the host 130 at 413. After the host 130 receives the first block of data at 413, the host instructs the second data storage drive 120 to receive the first data block from the host 407. The second data storage drive 120 receives the first block of data at 312 and writes the second block of data to the medium of the second data storage drive at 314. Concurrently, while the second data storage drive 120 is performing the receive step at 312 and write step at 314, the first data storage drive 110 reads the second block of data at 320, and transfers the second block of data at 321 to the cache 170. The host 130 then receives the second block of data at 423 from the first data storage drive 110. The data transfer interface 100 may repetitively transfer blocks of data by iterating the steps shown in FIG. 4. Because the second data storage device may be writing a block of data as the first data storage device reads out the next block of data, transfers may occur more efficiently.

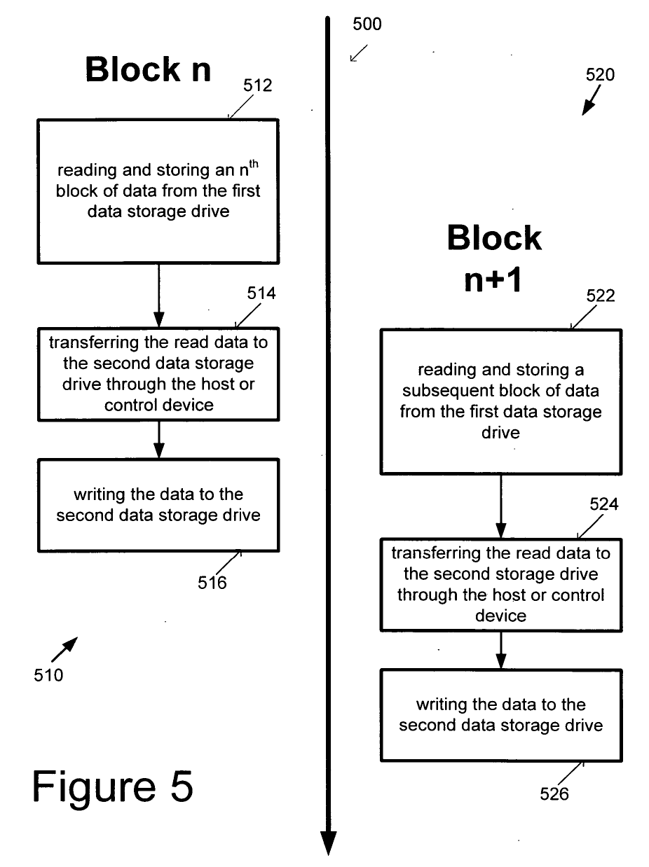

The process for repetitively transferring two blocks of data, for example, an n^{th} block 510 and an n+1^{th} block of data 520, is show in a flow diagram in FIG. 5. The flow diagrams for each column are arranged with respect to a time axis 500 to reflect the sequential and parallel relationships of the process for the blocks of data. In step 512, an n^{th} block of data is read from the first data storage drive 110 and stored in the cache 170 of the first data storage drive 110. After the reading and storing of the n^{th} block is completed, the host 130 requests a data transfer. The n^{th} stored data block is transferred to the host 130 (step 514). The host 130 then transmits the obtained data block to the second data storage drive 120 (step 514), while the first data storage drive 110 concurrently reads and stores data of a subsequent block n+1 (step 522) to the cache 170. The data transmitted to the second data storage drive 120 is written to the storage medium (step 516). Depending on the respective transfer speeds of the data storage drives 110 and 120, the reading and storing of data of block n+1 may already be completed before all data of the previous block n has been written to the second data storage drive 120. After the writing of data has been completed (step 516), the subsequent block n+1 (which already has been read from the first data storage drive 110) is requested from the host 130 and transferred to the host 130 from the cache 170 (steps 514 and 524). The data from block n+1 transmitted to the second data storage drive 120 is written to the second data storage drive 120.

This system may be applied in any type of computer system including a vehicle computer system such as a vehicle navigation system or a vehicle information system. Such systems may be updated on a continuing basis since navigation information changes as roads are built or new housing subdivisions are developed. Where a vehicle entertainment and information system comprises a single optical drive for compact disks (“CD”) and digital video disks (“DVD”), time-consuming update procedures may block the use of the DVD drive for other applications, such as listening to a CD or viewing a video program on a DVD. By employing a data transfer interface 100 capable of direct data transfers, the navigational update information may be transferred in a timely manner. The navigation data may be continually updated to a re-writeable storage medium such as a hard-disk drive and the optical drive, the CD or DVD drive, may be employed for the other entertainment purposes.

Applications for entertainment systems as mentioned above are also easily and efficiently implemented. CDs and DVDs may be used on computer systems and the data may be transferred to a hard drive for later viewing. The CDs may have database information or picture information that is transferred to the hard drive. The operator of the system may use the CD for entertainment, listening to audio CDs while viewing the transferred database and pictures since the information is presently stored on the hard drive. The data transfer may have been a direct transfer of information from the CD drive to the hard drive, minimizing the inconvenience of the transfer process to the operator.

The system may be a computer program product including a computer readable medium, such as any of the disk drive media described above. The computer readable medium may have stored on it a computer readable program code adapted to perform the steps for concurrently transferring data between data storage drives.

While various embodiments of the invention have been described, it will be apparent to those of ordinary skill in the art that many more embodiments and implementations are possible within the scope of the invention. Accordingly, the invention is not to be restricted except in light of the attached claims and their equivalents.

1. A data transfer interface comprising:
a host for controlling data transfer;
a first data storage drive including a memory for storing blocks of data;
a second data storage drive including a memory for storing blocks of data, and
a cache configured for communication with the first data storage drive;
where a first block of data is transferred from the first data storage drive to the cache and to the host for transfer to the second data storage drive, and the cache receives a second block of data from the first data storage drive while the first block of data is transferred to the second data storage drive.

2. The data transfer interface according to claim 1, where a first data transfer speed of the first data storage drive is slower than a second data transfer speed of the second data storage drive.

3. The data transfer interface according to claim 2, where data transfer is continuous.

4. The data transfer interface according to claim 1, where the first data storage drive is an optical disk drive and the second data storage drive is a hard disk drive.

5. The data transfer interface according to claim 1, where the host is adapted to receive the first block of data from the cache and to transfer the first block of data to the second data storage drive.

6. The data transfer interface according to claim 1, where the host controls reading the first block of data to the cache, and where the host controls writing the first block of data to the second data storage drive.

7. The data transfer interface according to claim 6, further comprising:
control lines connecting the host to the first data storage drive;
data lines connecting the host to the first data storage drive; and
read/write lines connecting the host to the first data storage drive.

8. The data transfer interface of claim 1, where the data transfer interface is located in a vehicle computer system.

9. The data transfer interface of claim 8, where the first block of data may represent video, audio, or navigation data.

10. The data transfer interface of claim 9 where the cache is located on the first data storage drive.

11. A method for transferring data comprising the steps of:
reading a first block of data from a first data storage drive;
transferring the first block of data to a control unit;
writing the first block of data to the second data storage drive; and
reading a second block of data from the first data storage drive while writing the first block of data to the second data storage drive.

12. The method according to claim 1l, where the step of reading the first block of data further comprises reading the first block of data into a cache located in the first data storage drive.

13. The method according to claim 1, where the time required for writing the first block of data to the second data storage drive is shorter than the time required for reading the second block of data from the first data storage drive.

14. The method according to claim 11, where the first data storage drive is an optical disk drive and the second data storage drive is a hard disk drive.

15. The method according to claim 11, where the step of reading data further comprises activating a look-ahead subroutine.

16. A method according to claim 13, where the step of reading the data further comprises continuously filling the cache with read data.

17. A computer program product comprising a computer readable medium having computer readable program code embodied within, the program code adapted to perform the steps of:
reading a first block of data from a first data storage drive;
transferring the first block of data to a temporary memory;
transferring the first block of data from the temporary memory to a second data storage drive;
writing the first block of data to the second data storage drive; and
reading a second block of data from the first data storage drive while writing the first block of data to the second data storage drive.

18. A computer program product of claim 16 further comprising the steps of:
transferring the first block of data from the temporary memory to the host; and
transferring the first block of data from the host to the second data storage drive.

19. A computer system for transferring data comprising:
a means for controlling the transfer of data;
a first means for storing data adapted for connection to the means for controlling data;
a second means for storing data adapted for connection to the means for controlling data; and
a means for temporarily locating data during the transfer of data,
where the second means for storing data is writing data to a memory during the same time as the first means for storing data is reading data to the means for temporarily locating data.

20. The computer system of claim 19 further comprising a means for improving the speed of the data transfer by analyzing the data accessed from the first data storage drive and predicting where in the first data storage drive next data will be read.
